(19) United States
(12) Patent Application Publication
(10) Pub. No.: US 2012/0313329 A1
(43) Pub. Date: Dec. 13, 2012

(54) Vented Dual Lip Seal And Method Of Making

(75) Inventor: Darin Battles, Dahlonega, GA (US)

(73) Assignee: FREUDENBERG-NOK GENERAL PARTNERSHIP, Plymouth, MI (US)

(21) Appl. No.: 13/157,707

(22) Filed: Jun. 10, 2011

(51) Int. Cl. F16J 15/32; B29C 65/02

(52) U.S. Cl. 277/565; 156/245

(57) ABSTRACT

A method of making a dual lip seal is provided including the steps of molding first and second seals to a respective first and second insert. The first and second seals each include a body portion molded to the first and second inserts and including a seal lip extending from the body portion. The body portion of the first and second seals includes a side surface including at least one projection and at least one recess. The at least one projection and the at least one recess of the first and second seals are aligned so that the at least one recess of the first and second seals each receive a corresponding one of the at least one projection of the other of the first and second seals. A heating process is then applied to the first and second seals to bond the seals together via vulcanization.

### FIELD

The present disclosure relates to a dual lip seal and more particularly to a vented dual lip seal and method of making.

### BACKGROUND

This section provides background information related to the present disclosure which is not necessarily prior art.

Vented dual lip seals have been utilized including a pair of identical seals mounted back to back and including a mechanical lock for interlocking the seals together. However, the interlocking design is not robust, and comes apart with a small amount of force. Accordingly, it is desirable in the art to provide a dual lip seal that provides a robust connection between a pair of seals.

### SUMMARY

This section provides a general summary of the disclosure, and is not a comprehensive disclosure of its full scope or all of its features.

The present disclosure provides a method of making a dual lip seal including the steps of molding first and second seals to a respective first and second insert. The first and second seals each include a body portion molded to the first and second inserts and including a seal lip extending from the body portion. The body portion of the first and second seals includes a side surface including at least one projection and at least one recess. The at least one projection and the at least one recess of the first and second seals are aligned so that the at least one recess of the first and second seals each receive a corresponding one of the at least one projection of the other of the first and second seals. A heating process is then applied to the first and second seals to bond the first and second seals together via vulcanization.

The above described method provides a dual seal assembly including a first seal molded to a first insert and a second seal molded to a second insert. The first and second seals each include a body portion molded to the respective first and second inserts and each including a seal lip extending from the body portion. The body portion of the first and second seals include a side surface including at least one projection and at least one recess. The first and second seals are bonded together with the first side surfaces of the first and second seals being aligned so that the at least one recess of the first and second seals each receive a corresponding one of the at least one projection of the other of the first and second seals.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a cross-sectional view of a vented dual lip seal according to the principles of the present disclosure;

FIG. 2 is a cross-sectional view of a single seal utilized for making the vented dual lip seal according to the principles of the present disclosure; and

FIG. 3 is a back side view of a single seal illustrating the projections and recesses molded into the seal body according to the principles of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner” and “outer,” and the like, may be used herein for ease of description to describe one element or feature's relationship to another element(s) or feature(s) as illustrated in the figures. The terms “axially” and “radially” are used to define directions relative to an axis of rotation of a shaft that is received in the seal.

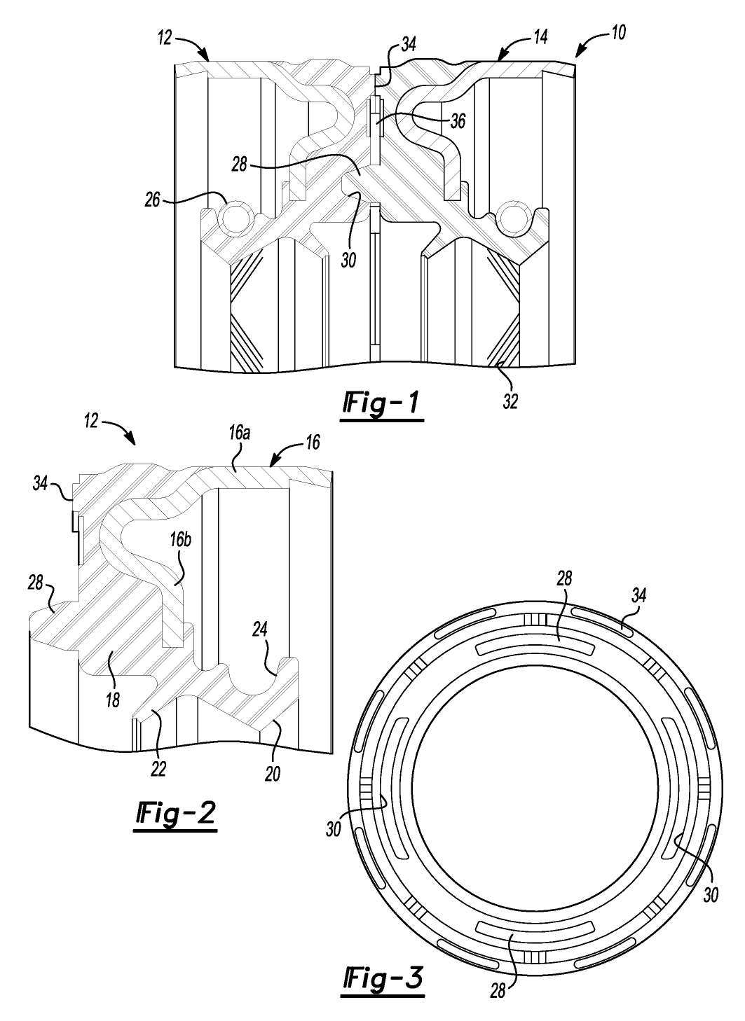

With reference to FIG. 1, a dual lip seal assembly 10 will now be described. The dual lip seal assembly 10 includes a first seal 12 and a second seal 14 which are disposed back to back and bonded together to form the dual seal assembly 10. Each of the seals 12, 14 are identical to one another and, therefore, a description of a single seal 12 will now be provided. The seal 12 includes an insert 16 having an outermost axially extending portion 16a that is adapted to be received in a bore of a housing or other structure. The insert includes a radially inwardly extending arm 16b which can be provided with bends of various shapes and forms therein. The insert 16 can be made from metal.

A seal body 18 is molded to the insert 16 and a primary seal lip 20 extends radially inwardly and axially from the body 18. A secondary seal lip 22 can also be provided extending radially inwardly and axially from body 18 in an axial direction opposite the primary seal lip 22. The primary seal lip 20 can be provided with a recessed groove 24 adapted to receive a garter spring 26 therein.

The seal body 18 and seal lips 20, 22 are preferably made from a rubber material and are molded to the insert 16 in a mold cavity. The body 18 is provided with one or more projections 28 extending in an axial direction relative to a center axis of the annular seal 12. The seal is shown including two projections 28, as best seen in FIG. 3, although more or fewer projections can be utilized. The seal also includes one or more recesses 30 that are sized and shaped so as to receive a corresponding projection 28 of the second seal 14.

In the assembled condition, as shown in FIG. 1, the two identical seals are placed back to back with the projections 28 of the first seal being received in the recesses 30 of the second seal and the projections 28 of the second seal being received in the recesses 30 of the first seal. The two seals 12, 14 can be clamped together between two blocks and a post molding curing processing can be applied via heating the assembled components so that the first and second seals become bonded together by vulcanization during the heating process. It is desirable that the bonding process be sufficient to prevent separation of the first and second seals 12, 14 during shipping, handling, and assembly of the dual lip seal in its desired environment.

It is noted that the main seal lip 20 can be provided with hydrodynamic grooves 32, as best seen in FIG. 1. It is further noted that alternative bonding techniques, other than vulcanization, can be utilized such as the use of adhesives that can be applied between the first and second seals 12, 14. The seals 12, 14 can also be provided with spacing bumpers 34 which hold the seals 12, 14 in a spaced relationship to define a vent gap therebetween. The vent gap 36 allows the ventilation of pressurized gases to escape the space between the two seals 12, 14.

The vented dual lip seal design allows for a single part design to be used for both halves of the seal. The seals are bonded together via vulcanization during a post-cure process that is typically applied to fully cure a molded seal component. Thus, the use of the vulcanization process for bonding the two seals eliminates the necessity for additional bonding steps. The vulcanization process securely joins the components of the seal so that they are robust and do not come apart during shipping, handling, and assembly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of making a dual lip seal, comprising the steps of:
molding first and second seals to a respective insert, said first and second seals each including a body portion molded to said insert and including a seal lip extending from said body portion, said body portion of said first and second seals including a side surface including at least one projection and at least one recess;
aligning said side surfaces of said first and second seals so that said at least one recess of said first and second seals each receive a corresponding one of said at least one projection of the other of said first and second seals; and
applying a heating process to said first and second seals to bond said first and second seals together via vulcanization.

2. The method according to claim 1, wherein said at least one projection includes plural projections and said at least one recess includes plural recesses.

3. A method of making a dual lip seal, comprising the steps of:
molding first and second seals to a respective insert, said first and second seals each including a body portion molded to said insert and including a seal lip extending from said body portion, said body portion of said first and second seals including a side surface including at least one projection and at least one recess;
aligning said side surfaces of said first and second seals so that said at least one recess of said first and second seals each receive a corresponding one of said at least one projection of the other of said first and second seals; and
bonding said first and second seals together.

4. The method according to claim 3, wherein said at least one projection includes plural projections and said at least one recess includes plural recesses.

5. A dual seal assembly, comprising:
a first seal molded to a first insert and a second seal molded to a second insert, said first and second seals each including a body portion molded to said respective first and second inserts and each including a seal lip extending from said body portion, said body portion of said first and second seals including a side surface including at least one projection and at least one recess, said first and second seals being bonded together with said side surfaces of said first and second seals being aligned so that said at least one recess of said first and second seals each receive a corresponding one of said at least one projection of the other of said first and second seals.

6. The dual seal assembly according to claim 5, wherein said first and second seals are bonded together via vulcanization.

7. The dual seal assembly according to claim 5, wherein said at least one projection includes plural projections and said at least one recess includes plural recesses.
